(19) United States
(12) Patent Application Publication
(10) Pub. No.: US 2026/0322024 A1
(43) Pub. Date: Oct. 15, 2026

(54) COMPRESSIVE SPACERS FOR POSITIONING CONNECTOR SUBSTRATES

(71) Applicant: Molex, LLC, Lisle, IL (US)

(72) Inventor: Arturo Casares Valdes, Guadalajara (MX)

(21) Appl. No.: 19/455,889

(22) Filed: Jan. 22, 2026

Related U.S. Application Data
(60) Provisional application No. 63/750,295, filed on Jan. 28, 2025.

(51) Int. Cl. H01R 13/502

(52) U.S. Cl. CPC H01R 13/502

(57) ABSTRACT

A connector includes a housing, a first substrate and a second substrate at least partially positioned within the housing, and a spacer positioned between the first substrate and the second substrate. The spacer has a spacer body comprising an upper elongated cross-member and a lower elongated cross-member coupled together via a first column and a second column. An aperture is positioned between the first column and the second column. A first coupling member couples the first column to a first coupling arm, and a second coupling member couples the second column to a second coupling arm. The spacer maintains a position of the first substrate and the second substrate within the connector, and biases the substrates against a housing of the connector.

### TECHNICAL FIELD

The present disclosure generally relates to electrical connectors and, in particular, to spacers for positioning printed circuit boards and other substrates in cable assemblies.

### BACKGROUND

Cable assemblies play a role in various electronic systems, providing essential connectivity between electrical components. In these assemblies, the precise positioning of printed circuit boards (PCBs) and like substrates is important, as the positioning directly impacts the force required to engage the cable assembly with its mating connector. Accurate PCB positioning not only enhances the overall performance of the connector but also contributes to the longevity and reliability of the cable assembly. Conventional approaches often allow for some degree of PCB movement or “float” within the enclosing features, resulting in positional variations that can negatively affect the performance of the connector.

### BRIEF SUMMARY

According to an aspect of the present disclosure, a connector is provided. The connector includes a housing, a first substrate, and a second substrate at least partially positioned within the housing, and a spacer positioned between the first substrate and the second substrate. The spacer has a spacer body comprising an upper elongated cross-member and a lower elongated cross-member coupled together via a first column and a second column. An aperture is positioned between the first column and the second column. A first coupling member couples the first column to a first coupling arm, and a second coupling member couples the second column to a second coupling arm.

The first substrate and the second substrate are positioned parallel with respect to one another, the first substrate being positioned above the second substrate, and the spacer being positioned between the first substrate and the second substrate in a vertical direction. The first substrate may be a first printed circuit board (PCB) and the second substrate may be a second printed circuit board, wherein each of the first PCB and the second PCB include a plurality of conductive pads. The spacer is positioned such that the spacer does not contact any of the plurality of conductive pads.

The connector may further include a first standoff projecting laterally from a first inner side surface of the housing, and a second standoff projecting laterally from a second inner side surface of the housing opposite the first inner side surface. The first substrate and the second substrate each include cutouts on lateral side surfaces thereof, where the first standoff and the second standoff are positioned in the cutouts of the first substrate and the second substrate. The first coupling arm and the second coupling arm comprise walls defining a recess, the first standoff and the second standoff being positioned in the recess of the first coupling arm and the second coupling arm.

The first standoff and the second standoff each include an interference that extends off a rear surface of a respective standoff relative to a front opening of the connector, the interference contacting an inner surface of one of the walls to prevent movement of the spacer. The first standoff and the second standoff each include a lateral projection that extends laterally from a side of a respective standoff towards an inner portion of the housing, the lateral projection contacting an inner side of one of the walls to resist further movement of the spacer. The interference has a triangular-shaped cross-section, and the lateral projection has a semicircle-shaped cross-section.

According to another aspect of the present disclosure, a spacer for maintaining positioning of at least one connector substrate is provided. The spacer has a spacer body including an upper elongated cross-member and a lower elongated cross-member coupled together via a first column and a second column, an aperture positioned between the first column and the second column, a first coupling member coupling the first column to a first coupling arm, and a second coupling member coupling the second column to a second coupling arm.

A first end of the upper elongated cross-member extends at least partially above the first coupling member, a first end of the lower elongated cross-member extends at least partially below the first coupling member, a second end of the upper elongated cross-member extends at least partially above the second coupling member, and a second end of the lower elongated cross-member extends at least partially below the second coupling member.

The spacer may further comprise a first recess positioned between the first end of the upper elongated cross-member and the first coupling member, and a second recess positioned between the first end of the lower elongated cross-member and the first coupling member, a third recess positioned between the second end of the upper elongated cross-member and the second coupling member, and a fourth recess positioned between the second end of the lower elongated cross-member and the second coupling member. The first coupling arm may comprise a first wall extending from the first coupling member, a second wall, and a first coupling arm mid-wall coupling the first wall to the second wall. The second coupling arm may comprise a third wall extending from the second coupling member, a fourth wall, and a second coupling arm mid-wall coupling the third wall to the fourth wall.

The first wall may have a width greater than that of the second wall such that the first wall, the second wall, and the first coupling arm mid-wall collectively define a first J-shaped hook. The third wall may have a width greater than that of the fourth wall such that the third wall, the fourth wall, and the second coupling arm mid-wall collectively define a second J-shaped hook. The upper elongated cross-member and the lower elongated cross-member are curved. The upper elongated cross-member curves upwards and the lower elongated cross-member curves downwards. The aperture may be an elongated aperture extending 50% or more than a length of at least one of the upper elongated cross-member and the lower elongated cross-member. The spacer body may be formed of at least one of a compressible material and a non-conductive material.

According to another aspect of the present disclosure, a connector is provided. The connector includes a housing, a first substrate and a second substrate at least partially positioned within the housing, and a spacer positioned between the first substrate and the second substrate. The spacer has a spacer body formed of a non-conductive, compressible material that maintains positioning of the first substrate and the second substrate.

The first substrate and the second substrate may be parallel, the first substrate being positioned above the second substrate, and the spacer being positioned vertically between the first substrate and the second substrate, the spacer contacting a bottom surface of the first substrate and a top surface of the second substrate. The first substrate may be a first printed circuit board (PCB) and the second substrate may be a second PCB, wherein each of the first PCB and the second PCB may comprise a plurality of conductive pads.

The spacer body may comprise an upper elongated cross-member and a lower elongated cross-member coupled together via a first column and a second column, an aperture positioned between the first column and the second column, a first coupling member coupling the first column to a first coupling arm, and a second coupling member coupling the second column to a second coupling arm. A first end of the upper elongated cross-member may extend at least partially above the first coupling member, and a first end of the lower elongated cross-member may extend at least partially below the first coupling member. A second end of the upper elongated cross-member may extend at least partially above the second coupling member, and a second end of the lower elongated cross-member may extend at least partially below the second coupling member.

The spacer may further comprise a first recess positioned between the first end of the upper elongated cross-member and the first coupling member, and a second recess positioned between the first end of the lower elongated cross-member and the first coupling member, a third recess positioned between the second end of the upper elongated cross-member and the second coupling member, and a fourth recess positioned between the second end of the lower elongated cross-member and the second coupling member.

The first coupling arm may comprise a first wall extending from the first coupling member, a second wall, and a first coupling arm mid-wall coupling the first wall to the second wall. The second coupling arm may comprise a third wall extending from the second coupling member, a fourth wall, and a second coupling arm mid-wall coupling the third wall to the fourth wall.

The first wall may have a width greater than that of the second wall such that the first wall, the second wall, and the first coupling arm mid-wall collectively define a first J-shaped hook, and the third wall may have a width greater than that of the fourth wall such that the third wall, the fourth wall, and the second coupling arm mid-wall collectively define a second J-shaped hook. The upper elongated cross-member and the lower elongated cross-member may be curved. The upper elongated cross-member may curve upwards and the lower elongated cross-member may curve downwards. The aperture may be an elongated aperture extending 50% or more than a length of at least one of the upper elongated cross-member and the lower elongated cross-member.

This summary is provided to introduce a selection of concepts in a simplified form that are further described below in the detailed description, and is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top, front perspective view of a connector according to various embodiments of the present disclosure.

FIG. 2 is a bottom, front perspective view of the connector according to various embodiments of the present disclosure.

FIGS. 3 and 4 are top, front perspective views of a spacer of the connector positioned between two substrates according to various embodiments of the present disclosure.

FIGS. 5 and 6 are bottom, front perspective views of the spacer of the connector positioned between two substrates according to various embodiments of the present disclosure.

FIGS. 7 and 8 are top, front perspective views of the spacer of the connector according to various embodiments of the present disclosure.

FIGS. 9 and 10 are bottom, front perspective views of the spacer of the connector according to various embodiments of the present disclosure.

FIG. 11 is a front view of the spacer of the connector according to various embodiments of the present disclosure.

FIG. 12 is a rear view of the spacer of the connector according to various embodiments of the present disclosure.

FIG. 13 is a partial top perspective view of the connector according to various embodiments of the present disclosure.

FIG. 14 is an enlarged partial top perspective view of the connector showing a standoff of a connector housing according to various embodiments of the present disclosure.

FIG. 15 is a front perspective view of the connector according to various embodiments of the present disclosure.

FIG. 16 is another front perspective view of the connector comprising a spacer according to various embodiments of the present disclosure.

### DETAILED DESCRIPTION

The present disclosure relates to electrical connectors and, more specifically, to spacers for positioning printed circuit boards (PCBs) and other substrates in connectors and connector assemblies. The spacers described herein can provide improved positioning and alignment of connector components, enhancing the overall performance and reliability of electrical connections.

In some conventional connectors, PCBs and other substrates may be prone to movement or “float” within a connector housing during connection and disconnection cycles. This movement can lead to several issues that may degrade the performance and longevity of both the PCBs and the connector itself. For instance, excessive movement of substrates may cause misalignment of conductive pads, resulting in intermittent or unreliable electrical connections. Additionally, the repeated stress from substrate movement may lead to wear on solder joints, traces, or other delicate components on the PCBs. From a signal quality perspective, inconsistent positioning of substrates can introduce variations in impedance and signal path lengths, which may degrade signal integrity, especially in high-speed data applications. These variations can manifest as increased signal attenuation, crosstalk, or reflections, limiting the bandwidth and overall performance of the connector. Moreover, in some cases, substrate movement can lead to mechanical wear on connector housing components, further compromising the long-term reliability of the connector.

To avoid float, in some connector designs, PCBs may be directly positioned against hard surfaces of the connector housing. This approach can introduce certain challenges. The rigid nature of the housing material can cause damage to the PCBs over time, especially during repeated connection and disconnection cycles or when the connector is subjected to mechanical stress. The direct contact between the PCB and the housing may lead to abrasion of the PCB surface, damaging pads, traces, or other sensitive components. Additionally, the hard surface of the housing may not provide adequate cushioning against vibrations or impacts, which could result in microfractures in the PCB or compromise solder joints. Furthermore, the lack of a compliant interface between the PCB and the housing can limit the ability to accommodate manufacturing tolerances or thermal expansion differences, leading to uneven pressure distribution or gaps that could affect the electrical performance of the connector.

Accordingly, various embodiments are described herein for a connector with substrate positioning and alignment. The connector includes a housing, one or more substrates (e.g., printed circuit boards), and a spacer positioned among or biasing the one or more substrates. In some embodiments, the spacer includes a body with upper and lower elongated cross-members connected by columns, having an aperture defined therebetween. Coupling members and coupling arms extend from ends of the spacer body, allowing the spacer to interface with the connector housing and maintain proper substrate positioning.

The spacer body can be formed of a compressible, non-conductive material that helps maintain consistent pressure on the substrates while preventing unwanted movement or float within the connector housing. This can help address issues found in conventional connectors, such as misalignment of conductive pads, wear on PCB components, and signal integrity degradation due to inconsistent substrate positioning. The structure of the spacer, including curved cross-members and strategically placed notches and recesses, allow for intentional spacer deformation and provide better accommodation of manufacturing tolerances and more even pressure distribution, improving the overall performance and longevity of the connector assembly.

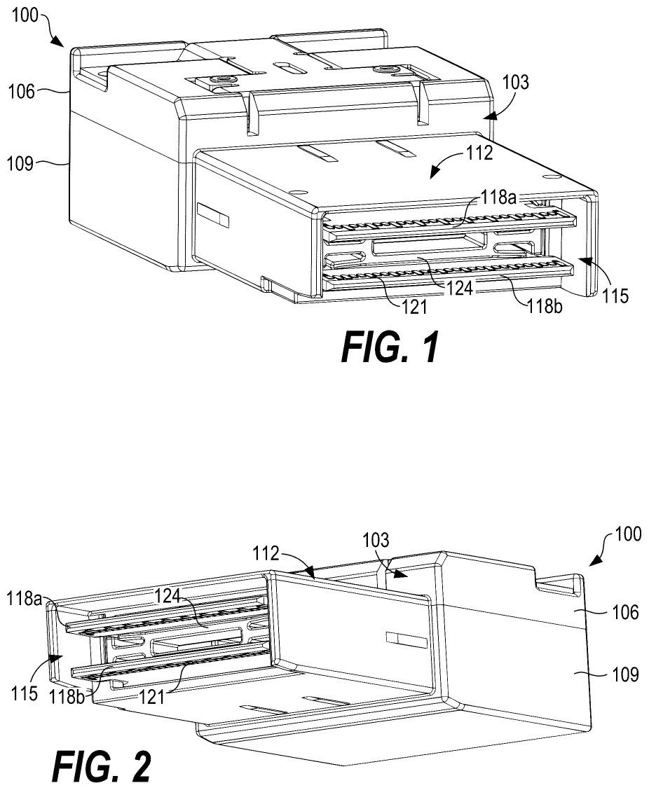

Turning now to the drawings, FIG. 1 shows a top perspective view of a connector 100 according to various embodiments. FIG. 2 shows a bottom perspective view of the connector 100. The connector 100 and its components may not necessarily be shown to scale in the figures, as the drawings are intended to illustrate the principles and features of the disclosure rather than exact proportions. In some cases, certain features or elements of the connector 100 may be exaggerated or simplified in the drawings to facilitate understanding of the disclosed concepts and structures.

The connector 100 includes a connector housing 103. A multitude of arrangements can be provided to form the connector housing 103. As but one example, the connector housing 103 can include an upper housing portion 106 and a lower housing portion 109 that can be snapped, clamped, or otherwise coupled to one another to enclose various electronic components, such as one or more printed circuit boards (PCBs), among other components. In some embodiments, the upper housing portion 106 and the lower housing portion 109 together define a connector portion 112 adapted for insertion into a port of an external connector, socket, device, which is omitted from the figures for explanatory purposes. However, the connector portion 112 is not required and other form factors of a housing 103 can be employed.

The housing 103 can be constructed from a variety of materials, depending on the specific requirements of the connector 100. In some embodiments, the housing 103 can be formed from a metal material, such as aluminum, stainless steel, or zinc alloy, to provide structural support and electromagnetic shielding. The use of a metal backshell can offer enhanced durability and protection against environmental factors. In other embodiments, the housing 103 may be fabricated from high-performance polymers or composite materials. These materials may include engineering plastics such as polyetherimide (PEI), polyetheretherketone (PEEK), or liquid crystal polymers (LCP). In some embodiments, a combination of materials may be used, such as a metal-plated polymer, to achieve a balance of properties.

The housing 103 of the connector 100 can include a front opening 115. To this end, the connector 100 can include one or more substrates 118a, 118b (collectively “substrates 118”) positioned in the front opening 115. For instance, the substrates 118 can include an upper substrate 118a and a lower substrate 118b. The substrates 118 can include conductive pads 121 such that, when the connector portion 112 is inserted into a port of another connector, terminals, traces, etc. contact the conductive pads 121 of the substrates 118 to form an electrical connection therewith. Upon the electrical connection, data signals may be communicated through the connector 100, as can be appreciated.

The positioning of the substrates 118 in the housing 103 or the connector portion 112 thereof in various embodiments, can maintain signal integrity and ensure reliable data communication through the connector 100. Precise alignment of the substrates 118 within the front opening 115 may help ensure that the conductive pads 121 on the substrates 118 make proper contact with the corresponding terminals or traces of a mating connector (not shown). This alignment can be important for establishing consistent electrical connections and minimizing signal loss or distortion during data transmission.

In some cases, even small variations in the positioning of the substrates 118 can impact the quality of the electrical connections and, consequently, the overall performance of the connector 100. Proper substrate positioning can help maintain consistent impedance along the signal path, reduce crosstalk between adjacent signal lines, and minimize electromagnetic interference. These factors can contribute to preserving signal integrity and enabling high-speed data communication through the connector 100, which may be particularly important in applications requiring high bandwidth or low latency data transfer.

As such, in some embodiments, the connector 100 can include a spacer 124. The spacer 124 can be formed of a compressive and/or non-conductive material and can provide a biasing force against one or more of the substrates 118 of the connectors 100. For instance, the spacer 124 can bias the upper substrate 118a towards a top of the housing 103, while biasing the lower substrate 118b towards a bottom of the housing 103. As such, the spacer 124 can bias substrates 118 (e.g., PCBs) against a backshell or other hard surface of the housing 103. Thus, the spacer 124 can help maintain consistent positioning of the substrates 118, reducing variations in electrical contact and signal transmission characteristics over time and with repeated connector insertions. By providing a stable arrangement of substrates 118, the spacer 124 can contribute to more reliable and consistent performance of the connector 100 across various operating conditions and throughout its service life.

While not shown in the figures, it is understood that one or more cables can extend from a rear portion of the housing 103. These cables can be configured to transfer electrical signals to and from the conductive pads of the substrates 118. The cables can include multiple conductors or wires that correspond to different signal or power paths. The connection between the cables and the substrates 118 may be facilitated through various mechanisms, such as soldering, compression contacts, or board-to-board connectors. This arrangement can allow for the transmission of data, power, or control signals between the connector 100 and other components or devices in a comprehensive electronic system. The integration of these cables with the substrates 118 can enable the connector 100 to serve as an interface between different parts of a system.

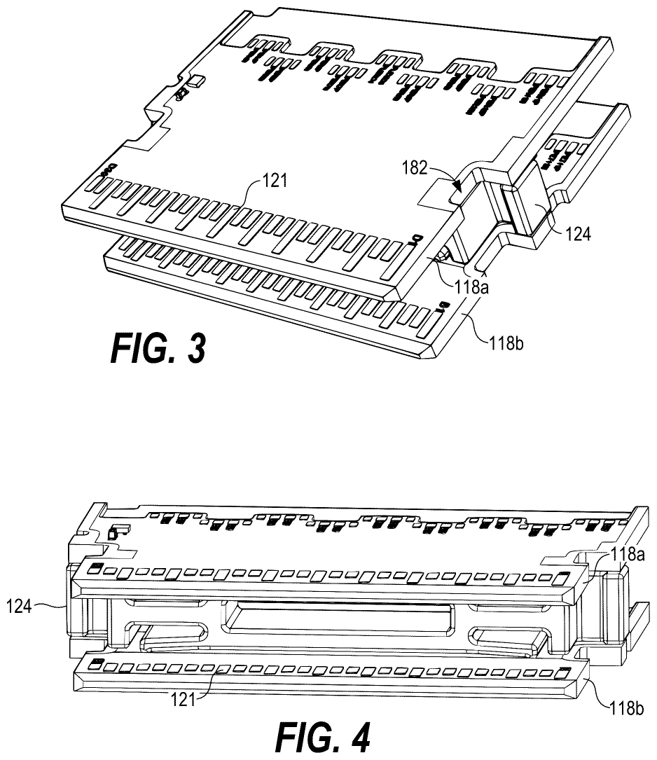

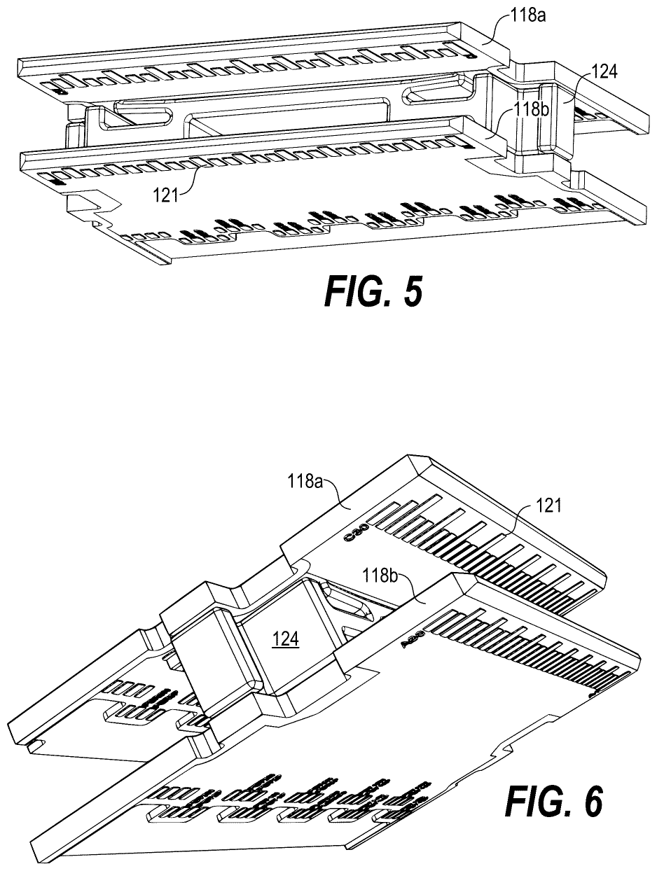

Moving along, FIGS. 3 and 4 show top perspective views and FIGS. 5 and 6 show lower perspective views of the upper substrate 118a, the lower substrate 118b, and the spacer 124. The housing 103 and other portions of the connector 100 are omitted for explanatory purposes in FIGS. 3-6. Referring collectively to FIGS. 3-6, in some embodiments, one or more of the substrates 118 of connector 100 can have geometries that conform to that of the spacer 124, allowing for a snug fit within the housing 103. For instance, the upper substrate 118a and lower substrate 118b can each include contoured edges or recesses that complement the profile of the spacer 124. For example, the substrates 118 can have cutouts 182, notches, or indentations that correspond to the geometry or profile of the spacer 124 and/or the housing 103. This allows the substrates 118 to nest closely with the spacer 124, reducing movement and improving positional stability within the housing 103.

The thickness of the substrates 118 can be determined to precisely fill vertical space between the spacer 124 and the inner surfaces of the housing 103. This tight vertical fit can help prevent unwanted movement of the substrates 118 in the direction perpendicular to their main surfaces. Additionally, the overall dimensions of the substrates 118 can be determine to account for the presence of the spacer 124, ensuring that when assembled, the combination of substrates 118 and the spacer 124 fits securely within the housing 103 without excessive gaps or pressure points.

The upper substrate 118a and the lower substrate 118b can be parallel with respect to one another. The upper substrate 118a can be positioned above the lower substrate 118b, and the spacer 124 can be positioned vertically between the upper substrate 118a and the lower substrate 118b. Such arrangement can cause the spacer 124 to contact a bottom surface of the upper substrate 118a to bias the upper substrate 118a towards a top of the housing 103 while contacting a top surface of the lower substrate 118b to bias the lower substrate 118b towards a bottom of the housing 103.

In some embodiments, the conductive pads 121 can be present on one side or both sides of each substrate 118. As shown in FIGS. 3-6, conductive pads 121 are positioned on both sides of each substrate 118, which can optimize signal routing and minimize interference. Moreover, when conductive pads 121 are present on both sides of a substrate 118, increased circuit density and more complex signal paths can be provided within a relatively compact form factor. The spacer 124 can be positioned and shaped in a manner that avoids direct contact with the conductive pads 121 on either side of the substrates 118. This positioning can help prevent potential short circuits or signal degradation that might occur if the spacer 124 were to interfere with the conductive pads 121. Thus, placement of the spacer 124 can maintain desired spacing and alignment of the substrates 118 while preserving the integrity and functionality of the conductive pads 121 on both sides of each substrate 118.

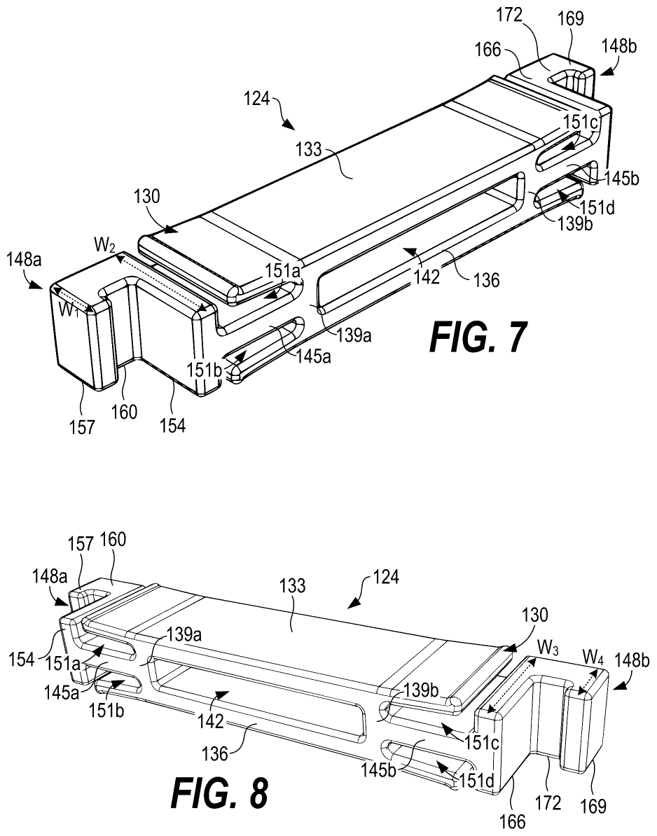

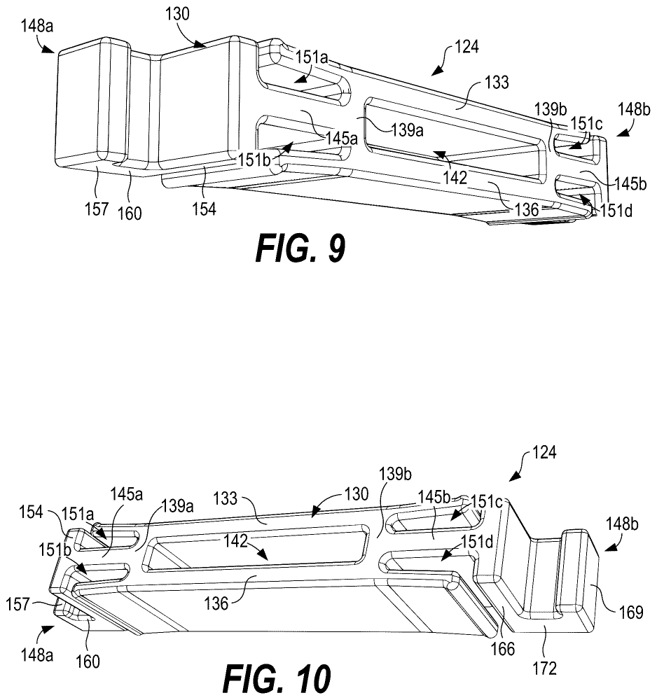

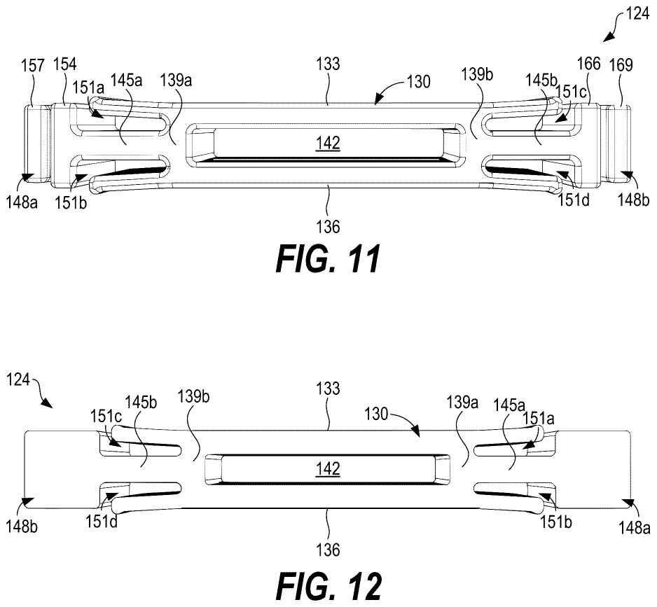

FIGS. 7 and 8 show top perspective views and FIGS. 9 and 10 show bottom perspective views of the spacer 124 according to various embodiments. FIGS. 11-12 show front and rear views of the spacer 124, respectively. Referring to FIGS. 7-12 collectively, the spacer 124 includes a spacer body 130. The spacer body 130 may be formed from one or more materials that exhibit compressible and/or non-conductive properties. The material selection for the spacer body 130 can be tailored to meet specific requirements of the connector application, such as temperature resistance, chemical compatibility, or mechanical durability. For instance, the spacer body 130 may be constructed from elastomeric polymers, thermoplastic elastomers, or specially formulated plastics that provide the desired combination of compressibility and electrical insulation. As but one example, the spacer body 130 can be formed from polyamide 6 (PA6), among other potential materials. Other potential materials for the spacer body 130 can include polyamide 66 (PA66), polybutylene terephthalate (PBT), nylon, silicone rubbers, polyurethanes, engineered thermoplastics, or any combination thereof. Moreover, in various embodiments, the material can be reinforced or impregnated with various materials. For instance, the materials can be reinforced or impregnated with glass or ceramic fibers, carbon fibers, and so forth to enhance desired material properties, as can be appreciated.

The spacer body 130 can include an upper elongated cross-member 133 and a lower elongated cross-member 136. The upper elongated cross-member 133 and the lower elongated cross-member 136 can be coupled together via one or more columns and can be positioned approximately parallel with respect to one another. For example, the spacer body 130 can include a first column 139a and a second column 139b (collectively “columns 139”). However, it is understood that a single column can couple the upper elongated cross-member 133 and the lower elongated cross-member 136, or there can be three columns 139, four columns 139, and so on.

In some embodiments, the spacer body 130 includes an aperture 142 positioned between the first column 139a and the second column 139b. The aperture 142, in some embodiments, can be elongated and thus can extend 50% or more than a length of at least one of the upper elongated cross-member 133 and the lower elongated cross-member 136. Thus, in the example of FIGS. 7-12, the aperture 142 is generally rectangular-shaped, but it is understood that the aperture 142 can be ovular-, circular-, or square-shaped in some embodiments.

The aperture 142 can include a void between the first column 139a and the second column 139b, which can allow for increased flexing and deformation of the spacer body 130 when under compression. This additional flexibility may enable the spacer 124 to better accommodate variations in substrate thickness or positioning, improving its ability to maintain consistent pressure on the substrates 118. Furthermore, the presence of the aperture 142 can reduce the overall mass of the spacer 124, which may result in material savings during manufacturing. This reduction in material usage can lower production costs and make the spacer 124 lighter, which may be beneficial in applications where minimizing the overall weight of the connector 100 is desirable. The aperture 142 can also facilitate more uniform compression of the spacer body 130, as the aperture 142 enables the upper elongated cross-member 133 and lower elongated cross-member 136 to deform more freely towards each other when pressure is applied.

The spacer body 130 can further include a first coupling member 145a and a second coupling member 145b. Moreover, the spacer body 130 can further include a first coupling arm 148a and a second coupling arm 148b that can engage with corresponding features of the housing 103 to further retain the spacer 124 in the housing 103. The first coupling arm 148a can be positioned towards a first distal end of the spacer body 130, whereas the second coupling arm 148b can be positioned towards a second distal end of the spacer body 130.

The first coupling member 145a couples the first column 139a to the first coupling arm 148a, whereas the second coupling member 145b couples the second column 139b to a second coupling arm 148b. In some embodiments, a first end (e.g., a left-most end) of the upper elongated cross-member 133 can extend at least partially above the first coupling member 145a, and a first end of the lower elongated cross-member 136 can extend at least partially below the first coupling member 145a. Similarly, a second end (e.g., a right-most end) of the upper elongated cross-member 133 can extend at least partially above the second coupling member 145b, and a second end of the lower elongated cross-member 136 can extend at least partially below the second coupling member 145b.

A first recess 151a can be positioned between the first end of the upper elongated cross-member 133 and the first coupling member 145a, and a second recess 151b can be positioned between the first end of the lower elongated cross-member 136 and the first coupling member 145a. Likewise, a third recess 151c can be positioned between the second end of the upper elongated cross-member 133 and the second coupling member 145b, and a fourth recess 151d positioned between the second end of the lower elongated cross-member 136 and the second coupling member 145b. The recesses 151a . . . 151d can be collectively referred to herein as recesses 151.

The recesses 151 and/or the material of the spacer 124 can permit ends of the upper elongated cross-member 133 and the lower elongated cross-member 136 to flex or otherwise deform upon contact with a substrate 118. The flexing can thus accommodate variations in a thickness of the one or more substrates 118 while maintaining a desired amount of pressure. When the spacer 124 is compressed between the substrates 118, the ends of the cross-members 133, 136 can deflect slightly into these recesses 151, absorbing some of the compressive force and distributing it more evenly across the spacer body 130. This controlled deformation can help prevent excessive stress on any single point of the substrates 118 or the spacer 124 itself, extending the lifespan of both the connector 100 and/or the spacer 124 and the substrates 118 thereof. Additionally, ends of the cross-members 133, 136 being able to flex into the recesses 151 can provide a small amount of “give” that can facilitate assembly of the connector 100, allowing the spacer 124 to be slightly compressed during installation without risking damage to the substrates 118 or other connector components. In some embodiments, as the first elongated cross-member 133 and the second elongated cross-member 136 can curve upwards and downwards, respectively, the recesses 151 are triangular-shaped apertures when no normal force is applied. However, when normal force is applied to the first elongated cross-member 133 and the second elongated cross-member 136, the portion of the cross-members 133, 136 overlapping the recesses 151 can bend to be approximately horizontal, thereby providing rectangular-shaped recesses 151 during bending.

The first coupling arm 148a can include a first wall 154 extending from the first coupling member 145a, a second wall 157, and a mid-wall 160 coupling the first wall 154 to the second wall 157. The second coupling arm 148b can have a similar structure with a third wall 166, a fourth wall 169, and mid-wall 172 coupling the third wall 166 to the fourth wall 169. The first wall 154 can be positioned parallel to and can have a width W2 (FIG. 7) greater than a width W1 (FIG. 7) of the second wall 157, where the first wall 154 and the second wall 157 are separated by a distance defined by a width of the mid-wall 160. As such, the first wall 154, the second wall 157, and the mid-wall 160 collectively define a first J-shaped hook. Similarly, the third wall 166 can be positioned parallel to and can have a width W3 (FIG. 8) greater than a width W4 (FIG. 8) of the fourth wall 169, where the third wall 166 and the fourth wall 169 are separated by a distance defined by a width of the mid-wall 172. Hence, the third wall 166, the fourth wall 169, and the mid-wall 172 together define a second J-shaped hook. As such, walls of the coupling arms 148 may form J-shaped hooks.

In various embodiments, the wall 157 of the first coupling arm 148a and the wall 169 of the second coupling arm 148b are omitted. As such, in these embodiments, the first wall 154 and the mid-wall 160 can together define a first L-shaped hook. Similarly, the third wall 166 and the mid-wall 172 can together define a second L-shaped hook.

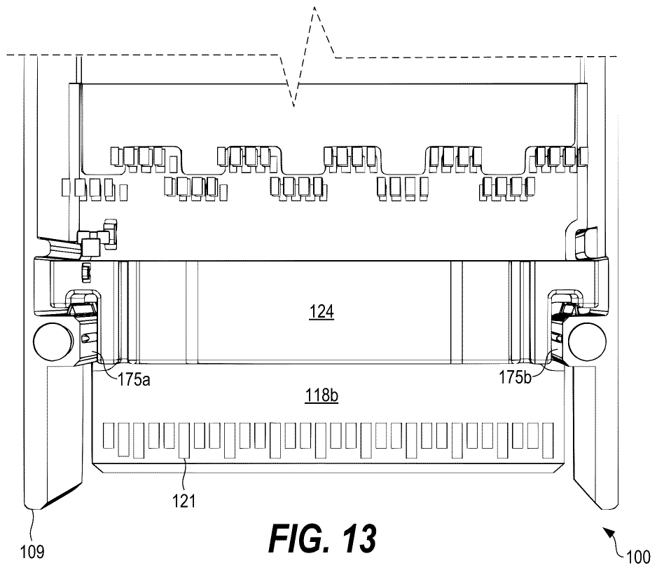

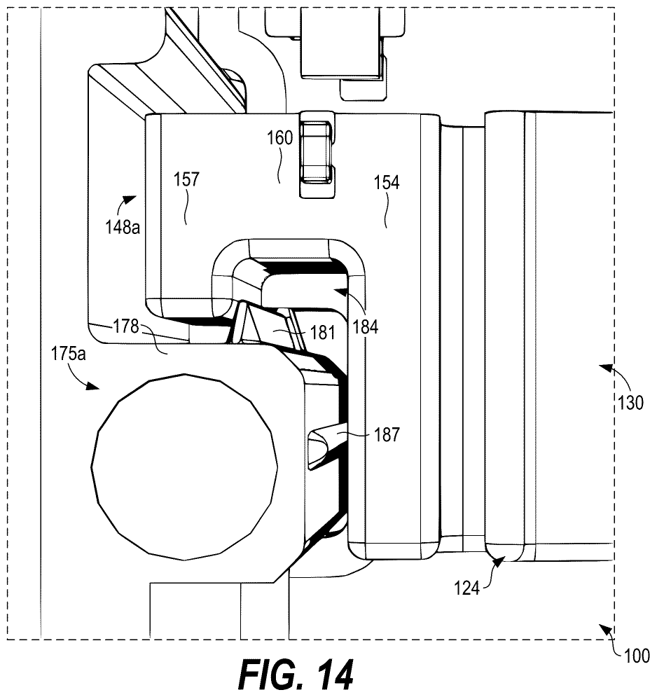

Turning now to FIG. 13, a top view of the connector 100 with the upper housing portion 106 and the upper substrate 118a omitted is shown for explanatory purposes. The housing 103 can include a backshell having one or more standoffs 175a, 175b (collectively “standoffs 175”). The standoffs 175 may project from an inner surface of the housing 103 and can extend vertically in the housing 103, as will be described. An enlarged view of the standoff 175 shown relative to the spacer 124 is shown in FIG. 14. Referring to FIGS. 13 and 14 collectively, the coupling arms 148 of the spacer 124 can extend around the standoffs 175 such that an interference connection is formed between the standoffs 175 and distal ends of the spacer 124.

The standoffs 175 can include standoff bodies 178 that extend vertically from a bottom surface of the housing 103 to a top surface of the housing 103. The standoffs 175 can be positioned in cutouts 182 (FIG. 3) or notches made in lateral sides of one or more of the substrates 118, and can be positioned in recesses 184 of the coupling arms 148 of the spacer 124. In some embodiments, the standoff bodies 178 include an interference 181 that can further extend into the recess 184 defined by the first wall 154, the second wall 157, and the mid-wall 160 extending therebetween. For instance, the interference 181 can extend off a rear surface of the standoff 175 relative to the front opening 115 (FIG. 1) of the connector 100. The interference 181 can contact an inner surface of the second wall 157, for example, preventing lateral movement of the spacer 124 while some flexibility is provided due to a material of the spacer 124. The interference 181 can include a triangular-shaped cross-section in some embodiments. However, in alternative embodiments, the interference 181 can have a square-, rectangular-, or semicircle-shaped cross-section.

Further, the standoff body 178 can include a lateral projection 187 that extends laterally from a side of the respective standoff 175 towards an inner portion of the housing 103. The lateral projection 187 can contact an inner side of the first wall 154 and can further resist lateral movement of the spacer 124 as positioned in the housing 103. The lateral projection 187 can have a semicircle-shaped cross-section in some embodiments. However, in alternative embodiments, the interference 181 can include a square-, rectangular-, or triangular-shaped cross-section. While FIG. 14 shows the first coupling arm 148a and a first standoff 175a, it is understood that the same principles can apply to the second coupling arm 148b and the second standoff 175b on an opposing side of the connector 100.

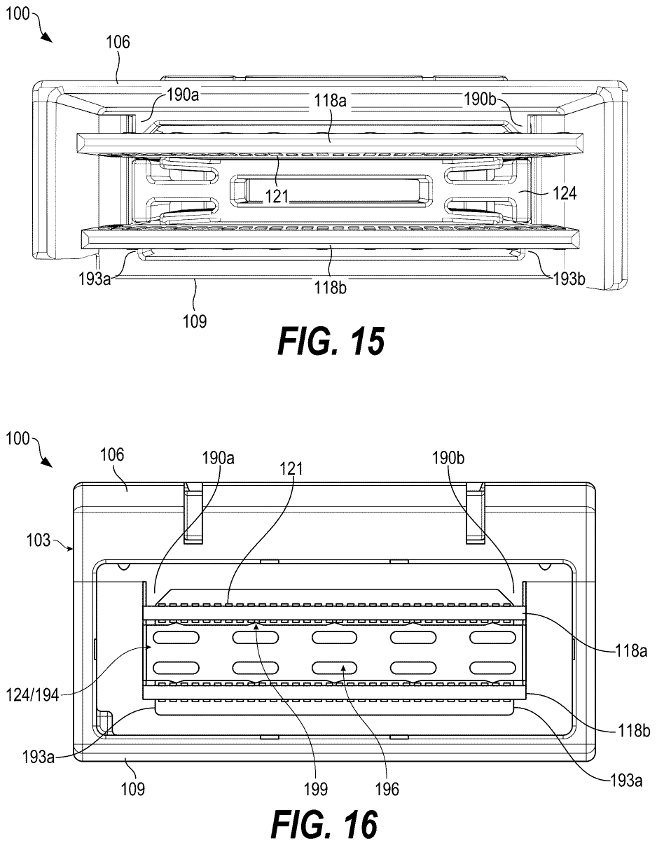

Turning now to FIG. 15, a front view of the connector 100 is shown according to various embodiments. The housing 103 of the connector 100 can further include upper stops 190a, 190b (collectively “upper stops 190”) and/or lower stops 193a, 193b (collectively “lower stops 193”). The upper stops 190 can act as hard stops preventing further upwards displacement of the upper substrate 118a, whereas the lower stops 193 can likewise act as hard stops preventing further downwards displacement of the lower substrate 118b. The upper stops 190 can include legs or like projections that extend downwards in the front opening 115 of the housing 103 to contact opposing sides of the upper substrate 118a. A bottom surface of the upper stops 190 can include a contact surface that is substantially parallel to the substrates 118a, 118b in some embodiments. The lower stops 193 can include steps or ledges that extend upwards in the front opening 115 of the housing 103 to similarly contact opposing sides of the lower substrate 118b. Upper surfaces of the steps or ledges can similarly be substantially parallel to the substrates 118a, 118b. Thus, the spacer 124 can bias the upper substrate 118a towards the top stops 190 and the lower substrate 118b towards the bottom stops 193.

In various embodiments, the manufacturing process for the connector 100 may begin with the provision of the lower housing portion 109. Once the lower housing portion 109 is provided, the lower substrate 118b may be positioned within the lower housing portion 109. The lower substrate 118b may then be aligned with any corresponding features or guides present in the lower housing portion 109 to ensure proper placement, such as the standoffs 175 if present in the lower housing portion 109. Thereafter, the spacer 124 may be introduced and positioned on top of the lower substrate 118b. The spacer 124 may then be oriented to align with any cutouts or notches in the lower substrate 118b, and may also engage with any standoffs 175 or other positioning or locating features present in the lower housing portion 109.

After the spacer 124 is in place, the upper substrate 118a may be added to the assembly. The upper substrate 118a may be positioned on top of the spacer 124, aligning with any corresponding features on the spacer 124 or the lower housing portion 109. Placement of the upper substrate 118a on the spacer 124 may cause the spacer 124 to slightly flex or otherwise deform. Once all internal components are properly arranged, the upper housing portion 106 may be brought into position to enclose the housing 103. The upper housing portion 106 may be designed to mate securely with the lower housing portion 109, potentially through snap-fit connections, fasteners, or other joining methods. All internal components can be secured within the housing 103 and the connector 100 can be prepared for any additional manufacturing or quality checks that may be required.

In some aspects, the spacer 124 can be formed as a single, integrated component during a molding process. The upper elongated cross-member 133, lower elongated cross-member 136, first column 139a, second column 139b, first coupling member 145a, second coupling member 145b, first coupling arm 148a, second coupling arm 148b, and/or other components thereof can all be formed simultaneously as part of the same molded structure. This integral construction can provide enhanced structural integrity and simplify manufacturing. The use of a single molding operation to form the entire spacer 124 can also help ensure consistent material properties throughout the component improving performance and durability.

As shown, the spacer 124 can have a symmetrical body, with the first and second halves of the spacer 124 being mirror images of each other. This symmetry can extend to various features of the spacer 124, including the positioning and dimensions of the coupling arms 145, the shape and size of the elongated aperture 142, and the curvature of the upper and lower elongated cross-members 133, 136. The symmetrical body can simply manufacturing of the spacer 124 and assembly of the connector 100. Additionally, the symmetrical structure of the spacer 124 can contribute to more uniform distribution of forces when the spacer 124 is compressed between the substrates 118, leading to improved performance and longevity of the connector 100.

Turning now to FIG. 16, another embodiment of the spacer 124 is shown according to various embodiments. The spacer 124 includes a generally rectangular body 194 having multiple rows of elongated apertures 196 positioned therein. For instance, in the embodiment of FIG. 16, the spacer 124 includes a top row of five elongated apertures 196 and a bottom row of five elongated apertures 196 in alignment with one another, although other arrangements can be employed (e.g., the top row of elongated apertures may be offset from or completely misaligned with the bottom row of elongated apertures). The size and positioning of the apertures 196 can permit flexing or other deformation of the spacer 124 to maintain constant biasing among the substrates 118.

The spacer 124 further includes a multitude of ridges 199 positioned on bottom and top surfaces of the body 194 of the spacer 124. For instance, ridges 199 positioned on a top surface of the spacer 124 can contact and bias the bottom surface of the upper substrate 118a towards top stops 190, whereas ridges 199 positioned on a bottom surface of the spacer 124 can contact and bias the upper surface of the lower substrate 118b towards bottom stops 193. As noted above, the substrates 118 can include PCBs or like circuit boards.

The various embodiments described herein for the spacer 124 can bias or force one or more PCBs into a hard stop or hard surface of a housing 103 of a connector 100 and maintain a position of the PCBs while the spacer 124 is compressed, flexed, or deformed. By doing so, the position of the PCBs are better controlled as the PCBs are not permitted to float and a tolerance of the position of the PCBs can be tighter than prior implementations.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A spacer for maintaining positioning of at least one connector substrate, comprising a spacer body, the spacer body comprising:
an upper elongated cross-member and a lower elongated cross-member coupled together via a first column and a second column;
an aperture positioned between the first column and the second column;
a first coupling member coupling the first column to a first coupling arm; and
a second coupling member coupling the second column to a second coupling arm.

2. The spacer according to claim 1, wherein:
a first end of the upper elongated cross-member extends at least partially above the first coupling member, and a first end of the lower elongated cross-member extends at least partially below the first coupling member; and
a second end of the upper elongated cross-member extends at least partially above the second coupling member, and a second end of the lower elongated cross-member extends at least partially below the second coupling member.

3. The spacer according to claim 2, further comprising:
a first recess positioned between the first end of the upper elongated cross-member and the first coupling member, and a second recess positioned between the first end of the lower elongated cross-member and the first coupling member; and
a third recess positioned between the second end of the upper elongated cross-member and the second coupling member, and a fourth recess positioned between the second end of the lower elongated cross-member and the second coupling member.

4. The spacer according to claim 1, wherein the first coupling arm comprises a first wall extending from the first coupling member, a second wall, and a first coupling arm mid-wall coupling the first wall to the second wall.

5. The spacer according to claim 1, wherein the second coupling arm comprises a third wall extending from the second coupling member, a fourth wall, and a second coupling arm mid-wall coupling the third wall to the fourth wall.

6. The spacer according to claim 5, wherein:
the first wall has a width greater than that of the second wall such that the first wall, the second wall, and the first coupling arm mid-wall collectively define a first J-shaped hook; and
the third wall has a width greater than that of the fourth wall such that the third wall, the fourth wall, and the second coupling arm mid-wall collectively define a second J-shaped hook.

7. The spacer according to claim 1, wherein the upper elongated cross-member and the lower elongated cross-member are curved.

8. The spacer according to claim 7, wherein the upper elongated cross-member curves upwards and the lower elongated cross-member curves downwards.

9. The spacer according to claim 1, wherein the aperture is an elongated aperture extending 50% or more than a length of at least one of the upper elongated cross-member and the lower elongated cross-member.

10. The spacer according to claim 1, wherein the spacer body is formed of at least one of: a compressible material and a non-conductive material.

11. A connector, comprising:
a housing;
a first substrate and a second substrate at least partially positioned within the housing; and
a spacer positioned between the first substrate and the second substrate, the spacer having a spacer body formed of a non-conductive, compressible material that maintains positioning of the first substrate and the second substrate.

12. The connector according to claim 11, wherein the first substrate and the second substrate are parallel, the first substrate being positioned above the second substrate, and the spacer being positioned vertically between the first substrate and the second substrate, the spacer contacting a bottom surface of the first substrate and a top surface of the second substrate.

13. The connector according to claim 11, wherein the first substrate is a first printed circuit board (PCB) and the second substrate is a second PCB, wherein each of the first PCB and the second PCB comprise a plurality of conductive pads.

14. The connector according to claim 11, wherein the spacer body comprises:
an upper elongated cross-member and a lower elongated cross-member coupled together via a first column and a second column;
an aperture positioned between the first column and the second column;
a first coupling member coupling the first column to a first coupling arm; and
a second coupling member coupling the second column to a second coupling arm.

15. The connector according to claim 14, wherein:
a first end of the upper elongated cross-member extends at least partially above the first coupling member, and a first end of the lower elongated cross-member extends at least partially below the first coupling member; and
a second end of the upper elongated cross-member extends at least partially above the second coupling member, and a second end of the lower elongated cross-member extends at least partially below the second coupling member.

16. The connector according to claim 15, further comprising:
a first recess positioned between the first end of the upper elongated cross-member and the first coupling member, and a second recess positioned between the first end of the lower elongated cross-member and the first coupling member; and
a third recess positioned between the second end of the upper elongated cross-member and the second coupling member, and a fourth recess positioned between the second end of the lower elongated cross-member and the second coupling member.

17. The connector according to claim 16, wherein the first coupling arm comprises a first wall extending from the first coupling member, a second wall, and a first coupling arm mid-wall coupling the first wall to the second wall.

18. The connector according to claim 17, wherein the second coupling arm comprises a third wall extending from the second coupling member, a fourth wall, and a second coupling arm mid-wall coupling the third wall to the fourth wall.

19. The connector according to claim 18, wherein:
the first wall has a width greater than that of the second wall such that the first wall, the second wall, and the first coupling arm mid-wall collectively define a first J-shaped hook; and
the third wall has a width greater than that of the fourth wall such that the third wall, the fourth wall, and the second coupling arm mid-wall collectively define a second J-shaped hook.

20. The connector according to claim 16, wherein the upper elongated cross-member curves upwards and the lower elongated cross-member curves downwards.
